(19) United States
(12) Patent Application Publication
(10) Pub. No.: US 2026/0301757 A1
(43) Pub. Date: Oct. 1, 2026

(54) SYSTEMS AND METHODS TO DETECT END OF SPEECH IN A NOISY ENVIRONMENT

(71) Applicant: Suki AI, Inc., Redwood City, CA (US)

(72) Inventors: Valerii Garnaga, San Jose, CA (US); Vamsi Reddy Chagari, Livermore, CA (US); Ajithkumar Warrier, Fremont, CA (US); Jian Feng, Snoqualmie, WA (US); Mona A. Sheikh, Redwood City, CA (US)

(21) Appl. No.: 17/954,895

(22) Filed: Sep. 28, 2022

(51) Int. Cl. G10L 21/0224; G10L 21/0208; G10L 21/0216

(52) U.S. Cl. CPC G10L 21/0224; G10L 2021/02087; G10L 2021/02168

(57) ABSTRACT

Systems and methods to detect end of speech in a noisy environment are disclosed. Exemplary implementations may: obtain, in an ongoing manner, audio information representing sound captured by an audio section of a client computing platform over an interval of time; analyze a portion of the audio information that represents the sound captured within a portion of the interval of time to identify a local maximum of a volume level of the sound captured within the portion of the interval of time; determine a volume level threshold based on the local maximum of the volume level of the sound; determine, in an ongoing manner as the audio information is obtained, whether a given volume level of the sound represented by the obtained audio information is less than the volume level threshold; and terminate, responsive to a determination that the given volume level is less than the volume level threshold.

### FIELD OF THE DISCLOSURE

The present disclosure relates to systems and methods to detect end of speech in a noisy environment.

### BACKGROUND

Users often times are required to provide dictations in noisy environments where many other voices and/or noises may be present in a background. Because of the noisy environment, speech recognition system may fail at detecting when the foreground/main user has stopped speaking.

### SUMMARY

When a user begins speaking, a volume level of a first portion of their speech is typically the loudest, and subsequently their volume level of their speech gets quieter.

The present disclosure describes a system that uses the highest volume within a first portion sound capture, that includes speech of a user, to determine a volume level threshold. For the rest of the sound capture, on a periodic basis, the volume may be compared to the volume level threshold. If the volume is lower than the volume level threshold at a given second, for example, then it may be determined that the user has stopped speaking.

Existing systems that attempt to solve the same problem use machine learning techniques that require more processing and time, or look for complete silence which is impossible in a noisy environment. This implementation uses a simple determination and therefore enables fast computation without the requirement of a quiet background and without expensive hardware, and expensive calculations and/or algorithms.

One aspect of the present disclosure relates to a system configured to detect end of speech in a noisy environment. The system may include one or more hardware processors configured by machine-readable instructions. The machine-readable instructions may include one or more instruction components. The instruction components may include computer program components. The instruction components may include one or more of audio obtainment component, analysis component, end determination component, termination component, speech recognition component, and/or other instruction components.

The audio obtainment component may be configured to obtain, in an ongoing manner, audio information representing sound captured by an audio section of a client computing platform over an interval of time. The sound represented by the audio information may include spoken input from a user. The spoken input may commence at an input beginning within the interval.

The analysis component may be configured to analyze a portion of the audio information that represents the sound captured within a portion of the interval of time to determine a volume level threshold based on a volume level of the sound within the portion of the interval of time. The beginning of the portion of the interval of time may be temporally at or near the input beginning. The sound captured within the portion of the interval of time may include at least part of the spoken input.

The end determination component may be configured to determine a potential end of spoken input based on a comparison of the volume level of the sound represented by the obtained audio information with the volume level threshold. The potential end of spoken input may be determined in an ongoing manner as the audio information is obtained.

The termination component may be configured to terminate, responsive to a determination that the given volume level is less than the volume level threshold, the capture of the sound by the audio section.

As used herein, the term “obtain” (and derivatives thereof) may include active and/or passive retrieval, determination, derivation, transfer, upload, download, submission, and/or exchange of information, and/or any combination thereof. As used herein, the term “effectuate” (and derivatives thereof) may include active and/or passive causation of any effect, both local and remote. As used herein, the term “determine” (and derivatives thereof) may include measure, calculate, compute, estimate, approximate, generate, and/or otherwise derive, and/or any combination thereof.

These and other features, and characteristics of the present technology, as well as the methods of operation and functions of the related elements of structure and the combination of parts and economies of manufacture, will become more apparent upon consideration of the following description and the appended claims with reference to the accompanying drawings, all of which form a part of this specification, wherein like reference numerals designate corresponding parts in the various figures. It is to be expressly understood, however, that the drawings are for the purpose of illustration and description only and are not intended as a definition of the limits of the invention. As used in the specification and in the claims, the singular form of ‘a’, ‘an’, and ‘the’ include plural referents unless the context clearly dictates otherwise.

### BRIEF DESCRIPTION OF THE DRAWINGS

FIG. 1 illustrates a system configured to detect end of speech in a noisy environment, in accordance with one or more implementations.

FIG. 2 illustrates a method to detect end of speech in a noisy environment, in accordance with one or more implementations.

FIG. 3 illustrates an example implementation of the system configured to detect end of speech in a noisy environment, in accordance with one or more implementations.

### DETAILED DESCRIPTION

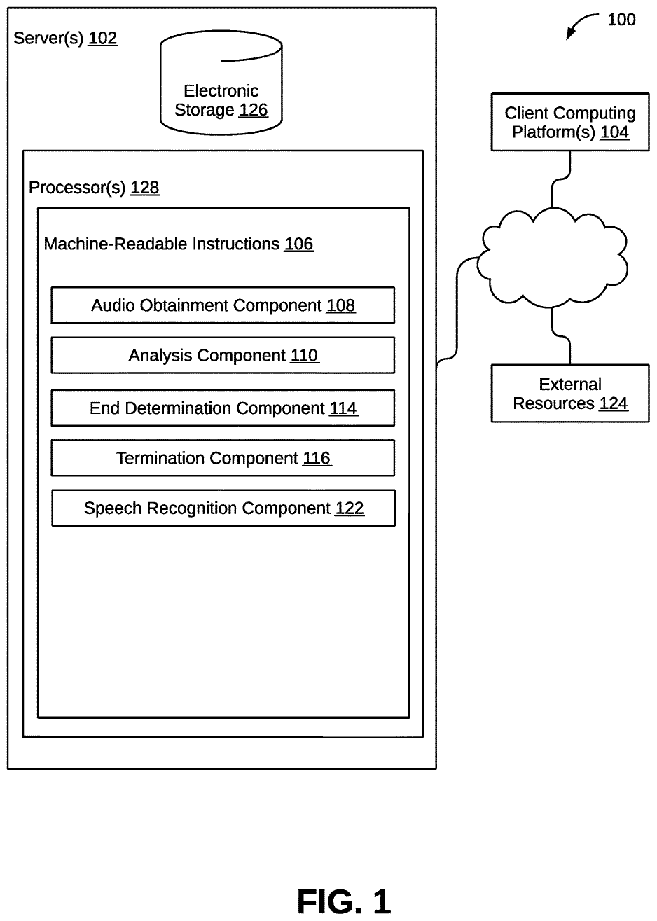

FIG. 1 illustrates a system 100 configured to detect end of speech in a noisy environment, in accordance with one or more implementations. In some implementations, system 100 may include one or more servers 102. Server(s) 102 may be configured to communicate with one or more client computing platforms 104 according to a client/server architecture and/or other architectures. Client computing platform(s) 104 may be configured to communicate with other client computing platforms via server(s) 102 and/or according to a peer-to-peer architecture and/or other architectures. Users may access system 100 via client computing platform(s) 104.

Server(s) 102 may be configured by machine-readable instructions 106. Machine-readable instructions 106 may include one or more instruction components. The instruction components may include computer program components. The instruction components may include one or more of audio obtainment component 108, analysis component 110, end determination component 114, termination component 116, speech recognition component 122, and/or other instruction components.

Audio obtainment component 108 may be configured to obtain, in an ongoing manner, audio information representing sound captured by an audio section of a client computing platform over an interval of time. The sound represented by the audio information may include spoken input from a user, background noise, music, and/or other sounds. The spoken input from the user may include words and/or phrases that comprise notes, commands, announcements, and/or other narrations or utterances. For example, the user may be audibly note taking. The background noise may include, for example, button clicking (e.g., keyboard, mouse), doors opening and closing, traffic, and/or other background noises that are unavoidable. The audio section may include an audio input sensor (e.g., a microphone) and/or other audio components.

The interval time may be a period of time that begins at an interval beginning. The interval beginning may refer to a point in time at which the interval of time begins. The capture of the sound, and the interval of time, may begin upon the user initiating the capture or at a defined time. For example, the initiation of the capture may include pressing a button in a combination on client computing platform 104, selecting a user interface element, and/or other initiations. In some implementations, the defined time may be unmodifiable. In some implementations, the defined time may be modifiable by the user and/or an administrative user via client computing platforms 104.

The spoken input may commence at an input beginning within the interval of time. The input beginning may be a point in time within the interval of time at which the spoken input begins. A “point in time”, as used herein, may be an epoch time, a date and time, and/or other format of time. In some implementations, the interval beginning may be reset to a format of time that includes the date and a time of zero.

Analysis component 110 may be configured to analyze a portion of the audio information that represents the sound captured within a portion of the interval of time to identify a local maximum of a volume level of the sound and/or other values that are based on an amplitude of soundwaves that comprise the sound captured within the portion of the interval of time. The volume level of the sound may refer to how quiet or loud the sound is, expressed in decibels. The volume level of the sound may vary throughout the interval of time. That is, the sound (e.g., voice of the user) may be quieter or louder at some points in time more than other points in time. The amplitude of the soundwaves may refer to a strength of the soundwaves relative to other soundwaves within the portion of the interval of time, which the other values different from the local maximum of the volume level may be determined based on. For example, the other values may include a maximum vertical displacement of the soundwaves, a change in pressure, and/or other values. The local maximum of the volume level may refer to the loudest that the sound is specifically within the portion of the interval of time. In some implementations, the local maximum of the volume level may refer to the loudest that the sound is specifically within the interval of time. In some implementations, the local maximum of the volume level may refer to the loudest that the sound is of the spoken input, i.e., the user's voice. Identifying the local maximum may include comparing the volume levels of the sound at a plurality of points in time within the portion of the interval of time to determine the highest volume level, and/or other identification techniques.

A beginning of the portion of the interval of time may be temporally at or near the input beginning. In some implementations, where the beginning of the portion is temporally near the input beginning, the beginning of the portion may be a particular quantity of time (e.g., one second, 500 milliseconds) before or after the input beginning. In some implementations, upon detection that the user began speaking, i.e., the input beginning, a delay subsequent to the detection may occur and then the beginning of the portion may be determined. The detection of the user speaking may be performed by audio obtainment component 108, analysis component 110, and/or other instruction component. The delay may be the particular quantity of time or some other amount of time for the beginning of the portion to be recorded.

In some implementations, the beginning of the portion of the interval of time may coincide with the input beginning. Meaning, the point in time at which the portion of the interval of time begins or is recorded to have begun may be the same as the point in time at which the user begins speaking, and thus the spoken input begins. The portion of the audio information representing the sound captured may include at least part of the spoken input. Such part of the spoken input may facilitate determination of the local maximum and/or the other values that are based on the amplitude of soundwaves. In some implementations, the input beginning of the spoken input and the beginning of the portion, that coincide, may be temporally at or near the interval beginning of the interval of time. In some implementations, upon detection that the user began speaking, i.e., the input beginning, capture of the sound, and thus the interval of time may begin. Thus, the input beginning of the spoken input and the beginning of the portion, that coincide, may be temporally at the interval beginning. In some implementations, there may be a time buffer between the input beginning and the beginning of the portion, that coincide, and the interval beginning. The time buffer may be the particular quantity of time (e.g., one second, 500 milliseconds, 5 seconds), and thus the input beginning and the beginning of the portion may be temporally near the interval beginning.

The portion of the interval of time may span for a particular amount of time from the beginning of the portion, for a particular amount of time from the input beginning, for a particular amount of words from the beginning of the portion, for a particular amount of words from the input beginning, for a particular amount of sentences from the beginning of the portion, for a particular amount of sentences from the input beginning, and/or other quantity. An end of the portion may be determined based on the particular amount of time, the particular amount of words, the particular amount of sentences, or other quantity. For example, the particular amount of time may be 3 seconds, 5 seconds, 7 seconds, and/or other amount of time. For example, the particular amount of words may be 10 words, 15 seconds, 17 words, and/or other amount of words. For example, the particular amount of sentences may be 1 sentence, 3 sentences, 5 sentences, and/or other amount of sentences. As such, in some implementations, the portion of the audio information that represents the sound, which is analyzed, may transpire from the beginning of the portion for the particular amount of time, words, and/or sentences. In some implementations, analysis component 110 may be configured to receive the particular amount of time, words, and/or sentences from client computing platform 104. In some implementations, the particular amount of time, words, and/or sentences may be unmodifiable.

Analysis component 110 be configured to determine a volume level threshold based on the local maximum of the volume level of the sound and/or the other values that are based on the amplitude of soundwaves. The volume level threshold may be value that facilitates determination of whether the speech, and thus the spoken input, has terminated by way of comparing the volume level threshold to volumes of the sound at a plurality of points in time during the interval of time subsequent to the portion. Determination of the volume level threshold may include applying the local maximum of the volume level and/or the other values that are based on the amplitude of soundwaves to a particular novel or known formula.

In some implementations, speech recognition component 122 may be configured to perform speech recognition on the audio information to determine the spoken input as the audio information is being obtained. The speech recognition may be in accordance with one or more novel and/or known techniques to convert the speech to text. The text may directly populate a document, be processed to determine the commands and complete the commands, and/or other actions.

End determination component 114 may be configured to determine a potential end of spoken input based on a comparison of the volume level of the sound represented by the obtained audio information with the volume level threshold. In some implementations, end determination component 114 may be configured to determine, in an ongoing manner as the audio information is obtained, whether a given volume level of the sound represented by the obtained audio information is less than the volume level threshold by comparing the given volume level of sound with the volume level threshold. The given volume level of the sound may be the volume level of the sound at some point in time during the interval of time. The term “ongoing manner” as used herein may refer to continuing to perform an action (e.g., determine, obtain) periodically (e.g., every second, every millisecond, etc.) until receipt of an indication to terminate or until a goal is accomplished, such as the given volume level of the sound being less than the volume level threshold. The indication to terminate may include powering off client computing platform 104, charging one or more of a battery of client computing platform 104, resetting client computing platform 104, and/or other indications of termination. For example, on a second-by-second basis, the given volume level of the sound at each second is compared with the volume level threshold to determine whether the volume level of the sound at that second is less than the volume level threshold. Thus, determining the potential end of spoken input may be based on the determination that the volume level of the sound is as less than the volume level threshold.

In some implementations, termination component 116 may be configured to terminate the capture of the sound by the audio section. The termination may be responsive to a determination that the given volume level is less than the volume level threshold and thus the potential end of spoken input. As such, upon the spoken input ending, the capturing may be terminated. In some implementations, terminating the capture of the sound may include termination the performance of the speech recognition. In some implementations, the termination of the capturing of the sound may be a particular amount of time after the potential end of spoken input, such as 5 seconds. In some implementations, the termination the performance of the speech recognition may be a particular amount of time after the potential end of spoken input.

In some implementations, termination component 116 may be configured to terminate the performance of the speech recognition only, while the capture of the sound by the audio section continues. As such, upon the spoken input ending, the performance of the speech recognition may be terminated. Subsequently, the capture of the sound may be terminated responsive to receipt of an indication to terminate the capture. The indication to terminate the capture may be similar or the same as the indications to begin the capture. In some implementations, termination component 116 may be configured to store the audio information, the text, the document, the commands, and/or other information obtained and/or determined subsequent to the termination of the capture in electronic storage 126.

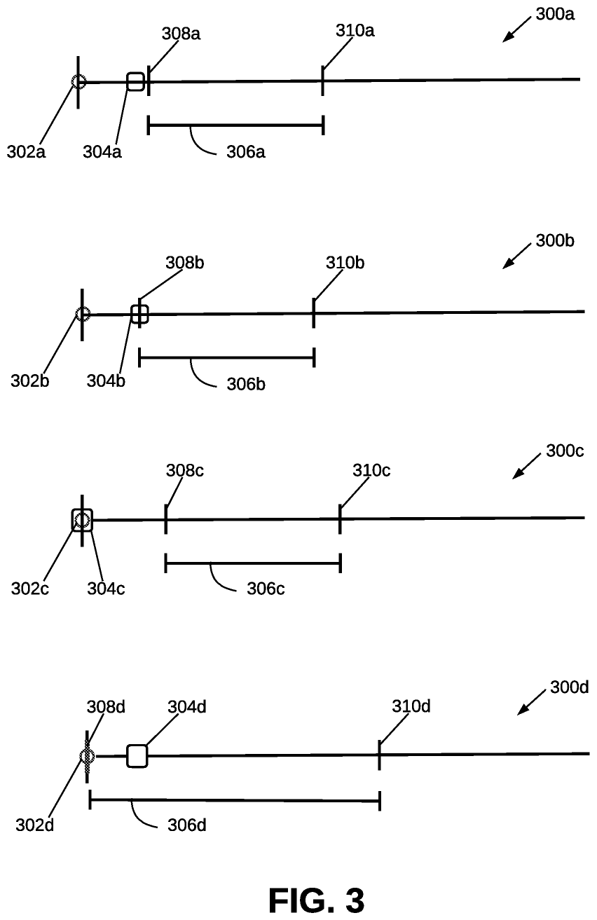

FIG. 3 illustrates an example implementation, in accordance with one or more implementation described herein. FIG. 3 illustrates intervals of time 300a, 300b, 300c, and 300d over which sound is captured by an audio section and represented by audio information (described in FIG. 1). Intervals of time 300a, 300b, 300c, and 300d may illustrate an interval beginning 302a, 302b, 302c, and 302d, respectively, and spoken input of a user that may begin at input beginning 304a, 304b, 304c, and 304d, respectively.

The audio information may be obtained, by system 100 described herein in FIG. 1, and a portion of the audio information that represents the sound captured within portions 306a, 306b, 306c, and 306d of intervals of time 300a, 300b, 300c, and 300d, respectively, may be analyzed to determine a volume level threshold. Portions 306a, 306b, 306c, and 306d may begin at portion beginning 308a, 308b, 308c, and 308d, respectively. Intervals of time 300a-d may illustrate variations of portion beginnings 308a-d and input beginnings 304a-d, respectively.

In interval of time 300a, portion beginning 308a may be temporally near input beginning 304a. Portion beginning 308a may be temporally near input beginning 304a responsive to detection that the user began to speak, i.e., input beginning 304a, and upon a delay subsequent to the detection.

In interval of time 300b, portion beginning 308b may temporally coincide with input beginning 304b. Portion beginning 308b and input beginning 304b may be temporally near interval beginning 302b. That is, there may be a time buffer between interval beginning 302b, and portion beginning 308b and input beginning 304b.

In interval of time 300c, portion beginning 308c may temporally coincide with input beginning 304c. Portion beginning 308c and input beginning 304c may temporally coincide with interval beginning 302c. In some implementations, interval beginning 302c may begin responsive to detection that the user began to speak, i.e., input beginning 304c. Therefore, input beginning 304c may be the same as interval beginning 302c.

Portions 306a, 306b, and 306c may span for a particular amount of time from portion beginning 308a-c, for a particular amount of time from input beginning 304a-c, for a particular amount of words from portion beginning 308a-c, for a particular amount of words from input beginning 304a-c, for a particular amount of sentences from portion beginning 308-c, or for a particular amount of sentences from input beginning 304a-c, respectively. Portion end 310a, 310b, and 310c may be determined based on the particular amount of time, the particular amount of words, or the particular amount of sentences.

In interval of time 300d, portion beginning 308d may be at interval beginning 302d regardless. In such variation, a portion end 310d of portion 306d may be determined based on a particular amount of words or a particular amount of sentences from input beginning 304d.

The volume level threshold may be determined based on a volume level of the sound within respectively portions 306a, 306b, 306c, and 306d described in FIG. 1.

Referring back to FIG. 1, in some implementations, server(s) 102, client computing platform(s) 104, and/or external resources 124 may be operatively linked via one or more electronic communication links. For example, such electronic communication links may be established, at least in part, via a network such as the Internet and/or other networks. It will be appreciated that this is not intended to be limiting, and that the scope of this disclosure includes implementations in which server(s) 102, client computing platform(s) 104, and/or external resources 124 may be operatively linked via some other communication media.

A given client computing platform 104 may include one or more processors configured to execute computer program components. The computer program components may be configured to enable an expert or user associated with the given client computing platform 104 to interface with system 100 and/or external resources 124, and/or provide other functionality attributed herein to client computing platform(s) 104. By way of non-limiting example, the given client computing platform 104 may include one or more of a desktop computer, a laptop computer, a handheld computer, a tablet computing platform, a NetBook, a Smartphone, a gaming console, and/or other computing platforms.

External resources 124 may include sources of information outside of system 100, external entities participating with system 100, and/or other resources. In some implementations, some or all of the functionality attributed herein to external resources 124 may be provided by resources included in system 100.

Server(s) 102 may include electronic storage 126, one or more processors 128, and/or other components. Server(s) 102 may include communication lines, or ports to enable the exchange of information with a network and/or other computing platforms. Illustration of server(s) 102 in FIG. 1 is not intended to be limiting. Server(s) 102 may include a plurality of hardware, software, and/or firmware components operating together to provide the functionality attributed herein to server(s) 102. For example, server(s) 102 may be implemented by a cloud of computing platforms operating together as server(s) 102.

Electronic storage 126 may comprise non-transitory storage media that electronically stores information. The electronic storage media of electronic storage 126 may include one or both of system storage that is provided integrally (i.e., substantially non-removable) with server(s) 102 and/or removable storage that is removably connectable to server(s) 102 via, for example, a port (e.g., a USB port, a firewire port, etc.) or a drive (e.g., a disk drive, etc.). Electronic storage 126 may include one or more of optically readable storage media (e.g., optical disks, etc.), magnetically readable storage media (e.g., magnetic tape, magnetic hard drive, floppy drive, etc.), electrical charge-based storage media (e.g., EEPROM, RAM, etc.), solid-state storage media (e.g., flash drive, etc.), and/or other electronically readable storage media. Electronic storage 126 may include one or more virtual storage resources (e.g., cloud storage, a virtual private network, and/or other virtual storage resources). Electronic storage 126 may store software algorithms, information determined by processor(s) 128, information received from server(s) 102, information received from client computing platform(s) 104, and/or other information that enables server(s) 102 to function as described herein.

Processor(s) 128 may be configured to provide information processing capabilities in server(s) 102. As such, processor(s) 128 may include one or more of a digital processor, an analog processor, a digital circuit designed to process information, an analog circuit designed to process information, a state machine, and/or other mechanisms for electronically processing information. Although processor(s) 128 is shown in FIG. 1 as a single entity, this is for illustrative purposes only. In some implementations, processor(s) 128 may include a plurality of processing units. These processing units may be physically located within the same device, or processor(s) 128 may represent processing functionality of a plurality of devices operating in coordination. Processor(s) 128 may be configured to execute components 108, 110, 114, 116, and/or 122, and/or other components. Processor(s) 128 may be configured to execute components 108, 110, 114, 116, and/or 122, and/or other components by software; hardware; firmware; some combination of software, hardware, and/or firmware; and/or other mechanisms for configuring processing capabilities on processor(s) 128. As used herein, the term “component” may refer to any component or set of components that perform the functionality attributed to the component. This may include one or more physical processors during execution of processor readable instructions, the processor readable instructions, circuitry, hardware, storage media, or any other components.

It should be appreciated that although components 108, 110, 114, 116, and/or 122 are illustrated in FIG. 1 as being implemented within a single processing unit, in implementations in which processor(s) 128 includes multiple processing units, one or more of components 108, 110, 114, 116, and/or 122 may be implemented remotely from the other components. The description of the functionality provided by the different components 108, 110, 114, 116, and/or 122 described below is for illustrative purposes, and is not intended to be limiting, as any of components 108, 110, 114, 116, and/or 122 may provide more or less functionality than is described. For example, one or more of components 108, 110, 114, 116, and/or 122 may be eliminated, and some or all of its functionality may be provided by other ones of components 108, 110, 114, 116, and/or 122. As another example, processor(s) 128 may be configured to execute one or more additional components that may perform some or all of the functionality attributed below to one of components 108, 110, 114, 116, and/or 122.

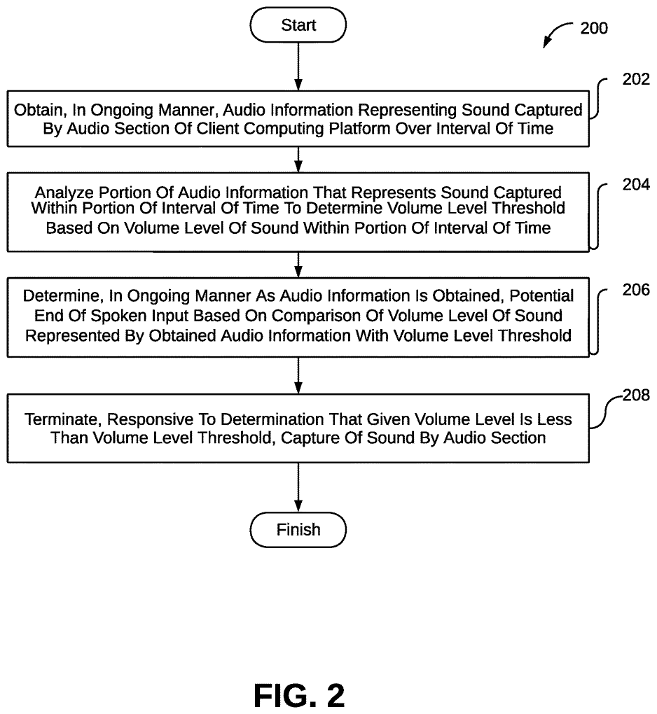

FIG. 2 illustrates a method 200 to detect end of speech in a noisy environment, in accordance with one or more implementations. The operations of method 200 presented below are intended to be illustrative. In some implementations, method 200 may be accomplished with one or more additional operations not described, and/or without one or more of the operations discussed. Additionally, the order in which the operations of method 200 are illustrated in FIG. 2 and described below is not intended to be limiting.

In some implementations, method 200 may be implemented in one or more processing devices (e.g., a digital processor, an analog processor, a digital circuit designed to process information, an analog circuit designed to process information, a state machine, and/or other mechanisms for electronically processing information). The one or more processing devices may include one or more devices executing some or all of the operations of method 200 in response to instructions stored electronically on an electronic storage medium. The one or more processing devices may include one or more devices configured through hardware, firmware, and/or software to be specifically designed for execution of one or more of the operations of method 200.

An operation 202 may include obtaining, in an ongoing manner, audio information representing sound captured by an audio section of a client computing platform over an interval of time. The sound represented by the audio information may include spoken input from a user. The spoken input may commence at an input beginning within the interval. Operation 202 may be performed by one or more hardware processors configured by machine-readable instructions including a component that is the same as or similar to audio obtainment component 108, in accordance with one or more implementations.

An operation 204 may include analyzing a portion of the audio information that represents the sound captured within a portion of the interval of time to determine a volume level threshold based on a volume level of the sound within the portion of the interval of time. A beginning of the portion of the interval of time may be temporally at or near the input beginning. The portion of the audio information representing the sound captured may include at least part of the spoken input. Operation 204 may be performed by one or more hardware processors configured by machine-readable instructions including a component that is the same as or similar to analysis component 110, in accordance with one or more implementations.

An operation 206 may include determining, in an ongoing manner as the audio information is obtained, a potential end of spoken input based on a comparison of the volume level of the sound represented by the obtained audio information with the volume level threshold. Operation 206 may be performed by one or more hardware processors configured by machine-readable instructions including a component that is the same as or similar to analysis component 110, in accordance with one or more implementations.

An operation 208 may include terminating, responsive to a determination that the given volume level is less than the volume level threshold, the capture of the sound by the audio section. Operation 208 may be performed by one or more hardware processors configured by machine-readable instructions including a component that is the same as or similar to volume level determination component 116, in accordance with one or more implementations.

Although the present technology has been described in detail for the purpose of illustration based on what is currently considered to be the most practical and preferred implementations, it is to be understood that such detail is solely for that purpose and that the technology is not limited to the disclosed implementations, but, on the contrary, is intended to cover modifications and equivalent arrangements that are within the spirit and scope of the appended claims. For example, it is to be understood that the present technology contemplates that, to the extent possible, one or more features of any implementation can be combined with one or more features of any other implementation.

1. A system configured to detect end of speech in a noisy environment, the system comprising:
one or more processors configured by machine-readable instructions to:
start recording of sound by an audio section of a client computing platform in the noisy environment, the sound recorded by the audio section including spoken input from a user and background noise from the noisy environment;
perform speech recognition on the sound recorded by the audio section to determine the spoken input;
detect, after starting the recording of the sound, a beginning of the spoken input from the user;
determine a local maximum of a volume level of the sound which occurs during a period from the beginning of the spoken input from the user to a completion of a given number of words or sentences spoken from the beginning;
dynamically determine a volume level threshold for a remainder of the recording of the sound by the audio section based on the local maximum of the volume level of the sound within the given number of the words or the sentences spoken from the beginning of the spoken input from the user;
determine, in an ongoing manner as the sound is continued to be recorded by the audio section, the volume level of the sound;
detect, responsive to a determination that the volume level of the sound is less than the volume level threshold, an end of the spoken input from the user; and
terminate, after a predetermined amount of time following detection of the end of the spoken input, the recording of the sound by the audio section.

2. The system of claim 1, wherein the background noise from the noisy environment includes clicking of a keyboard and/or a mouse.

3. The system of claim 1, wherein the sound recorded by the audio section further includes music.

4. The system of claim 1, wherein the recording of the sound by the audio section is started based on detection of the spoken input from the user.

5. (canceled)

6. (canceled)

7. The system of claim 1, wherein the one or more processors are further configured by the machine-readable instructions to store audio information representing the sound recorded by the audio section, subsequent to termination of the recording of the sound by the audio section.

8. The system of claim 1, wherein terminating the recording of the sound includes terminating the performance of the speech recognition.

9. The system of claim 1, wherein the recording of the sound starts without the volume level threshold.

10. (canceled)

11. A method to detect end of speech in a noisy environment, the method comprising:
starting recording of sound by an audio section of a client computing platform in the noisy environment, the sound recorded by the audio section including spoken input from a user and background noise from the noisy environment;
performing speech recognition on the sound recorded by the audio section to determine the spoken input;
detecting, after the starting of the recording of the sound, a beginning of the spoken input from the user;
determining a local maximum of a volume level of the sound which occurs during a period from the beginning of the spoken input from the user to a completion of a given number of words or sentences spoken from the beginning;
dynamically determining a volume level threshold for a remainder of the recording of the sound by the audio section based on the local maximum of the volume level of the sound within the given number of the words or the sentences spoken from the beginning of the spoken input from the user;
determining, in an ongoing manner as the sound is continued to be recorded by the audio section, the volume level of the sound; detecting, responsive to a determination that the volume level of the sound is less than the volume level threshold, an end of the spoken input from the user; and
terminating, after a predetermined amount of time following detection of the end of the spoken input, the recording of the sound by the audio section.

12. The method of claim 11, wherein the background noise from the noisy environment includes clicking of a keyboard and/or a mouse.

13. The method of claim 11, wherein the sound recorded by the audio section further includes music.

14. The method of claim 11, wherein the recording of the sound by the audio section is started based on detection of the spoken input from the user.

15. (canceled)

16. (canceled)

17. The method of claim 11, further comprising storing audio information representing the sound recorded by the audio section subsequent to the terminating of the recording of the sound by the audio section.

18. The method of claim 11, wherein terminating the recording of the sound includes terminating the performance of the speech recognition.

19. The method of claim 11, wherein the recording of the sound starts without the volume level threshold.

20. (canceled)

21. The system of claim 1, wherein the given number of the words or the sentences within which the local maximum of the volume level of the sound is determined for the dynamic determination of the volume level threshold is modified based on input from the client computing platform.

22. The system of claim 1, wherein the given number of the words or the sentences within which the local maximum of the volume level of the sound is determined for the dynamic determination of the volume level threshold is unmodifiable.

23. The method of claim 11, wherein the given number of the words or the sentences within which the local maximum of the volume level of the sound is determined for the dynamic determination of the volume level threshold is modified based on input from the client computing platform.

24. The method of claim 11, wherein the given number of the words or the sentences within which the local maximum of the volume level of the sound is determined for the dynamic determination of the volume level threshold is unmodifiable.
